(19) United States
(12) Patent Application Publication
(10) Pub. No.: US 2026/0157500 A1
(43) Pub. Date: Jun. 11, 2026

(54) FOLDABLE VANITY CASE

(71) Applicant: Jessica R. Brier, Fort Belvoir, VA (US)

(72) Inventor: Jessica R. Brier, Fort Belvoir, VA (US)

(21) Appl. No.: 19/414,474

(22) Filed: Dec. 10, 2025

Related U.S. Application Data
(60) Provisional application No. 63/730,442, filed on Dec. 10, 2024.

(51) Int. Cl. A45D 33/00; B60R 7/05

(52) U.S. Cl. CPC A45D 33/008; B60R 7/05

(57) ABSTRACT

A portable vanity case configured to provide a compact makeup and grooming station that can be easily transported and used in various environments. The vanity case includes a foldable body, having multiple panels that are adjoined at fold zones allowing the vanity case to be folded into a compact, closed configuration while maintaining internal volume and avoiding sharp creasing. The vanity case includes attachment means on a exterior side allowing it to attach to a vehicle visor. Support strap assemblies configured on an interior side are used to position one of the multiple panels in a substantially horizontal or angled orientation when the vanity case is in an unfolded orientation and attached to a vehicle visor during use. A mirror, lights, and storage structures are also included in the interior of the vanity case, providing the necessary elements for makeup and grooming.

### CROSS-REFERENCE TO RELATED APPLICATIONS

This application is a non-provisional application which claims priority to U.S. Provisional Patent Application No. 63/730,442 filed on Dec. 10, 2024, which is incorporated by reference in its entirety.

### FIELD OF INVENTION

The present disclosure generally relates to tools, systems, or features that relate to cosmetic application or self-grooming inside a vehicle.

### BACKGROUND

Applying makeup or performing personal grooming in a car is quite common, especially for those commuting who have limited time and busy schedules. In these situations, the inside of the vehicle becomes a temporary place to use cosmetic tools. Users may rely on visor mirrors, the rearview mirror, or handheld mirrors to see their face. They may do this while the car is parked or as a passenger during travel.

However, applying makeup or performing personal grooming in a car is challenging due to inadequate lighting, improper angles of car mirrors, and the lack of secure storage for makeup tools and products. The inside of a car does not provide much room for applying makeup. The interior of the vehicle provides very little space to move arms freely, hold products comfortably, or lay out several items at once. Car interiors are not designed for detailed visual tasks. Lighting inside the vehicle changes depending on the time of day, weather, window tint, and the car's direction. Sun visor lights and dome lights are usually too weak or uneven. The mirrors available in cars are small and positioned for driving, not for makeup. Their angle and distance from the user make it hard to see details clearly. Makeup items for use in cars are usually stored loosely in bags, cupholders, or glove compartments. Without flat surfaces or organizing features, tools can roll, fall, or get lost between seats. It is also difficult to keep multiple items within easy reach at the same time, which disrupts the process. These are just some of the challenges, which can result in poor application of the makeup, make the process slow, create a potential safety hazard, and disorganization.

Most existing solutions are either too bulky, unsafe for use within the vehicle, or fail to provide the functionality and ease needed for on-the-go grooming.

Thus, there is a clear need for a solution that makes it easier and more practical to apply makeup or perform personal grooming inside a vehicle.

### SUMMARY

The disclosed vanity case is unique when compared with other known vanity cases because it provides a structurally different device offering an improved solution to applying makeup or grooming safely and efficiently in a vehicle. The invention provides a portable and compact vanity case that combines a light source, mirror, storage compartments, and attachment option to a car interior. This design allows the vanity case to attach to a feature on a vehicle's interior, reducing the complexity of applying makeup by freeing the hands to apply makeup. The design also provides sufficient lighting, secures or holds makeup tools efficiently and reliably, and thus makes it easier and more convenient to apply makeup in a vehicle.

In one aspect, the present disclosure relates to a portable vanity case configured to provide a compact makeup and grooming station that can be easily transported and used in various environments. The vanity case includes a foldable, multi-panel body. In one aspect, the multi-panel body has a first end panel, a center panel, and a second end panel. The first and second end panels are foldably connected to the center panel by a pair of fold lines that define flexible fold zones. These fold zones allow the case to be folded into a compact, closed configuration while maintaining internal volume and avoiding sharp creasing.

In another aspect, the vanity case includes an interior side that faces the user during use and carries functional elements such as a main mirror that is integrated into the body, an optional detachable magnified mirror, lighting components, storage pockets, and brush holders. The opposing side is the exterior side, and basically forms the exterior of the folded case and includes attachment means for securing the case to a support structure, such as a vehicle visor. The exterior surface may be fashioned from fabric, leather, leather-like materials, or other suitable coverings and may be produced in a variety of colors and textures.

In a further aspect, the main mirror may be fixedly mounted on the first end panel and may occupy a substantial portion of that panel to provide a sufficiently large viewing area. A detachable magnified mirror may be removably secured to the integrated, main mirror using attachment means, such as suction cups located on its rear surface. A lighting element may be positioned adjacent the main mirror or along its perimeter, and a power button, which may be a brightness control type power button, and rechargeable power supply may be included. A charging port, such as a USB-C port, may also be included.

In yet another aspect, the panels that do not carry the main mirror may include various storage pockets such as slip-in pockets, mesh pockets, and zippered pockets, as well as elastic bands. A brush holder section may be provided using upper and lower elastic bands and a protective flap.

In still another aspect, the vanity case may include one or more support strap assemblies. Each support strap assembly may include a strap member having one end fixedly attached to the center panel and a second end configured to removably attach to the second end panel. These strap assemblies allow the second end panel to be positioned in a substantially horizontal or angled orientation when the vanity case is in an unfolded orientation and attached to a vehicle visor during use. This arrangement enables the second end panel to support objects while the vanity case is attached to a visor during use.

In another aspect, the vanity case may include an attachment member on the exterior side for securing the case to a vehicle visor. The attachment member may include clipping hooks, elastic loops, or other securing elements suitable for repeated engagement and disengagement. A closure mechanism may also be included to hold the vanity case in a folded orientation and may include a closure band with a snap fastener or other mechanisms such as magnetic closures, buckles, hook-and-loop, fasteners, or zippers.

Other aspects and advantages of the invention will be apparent from the following description and the appended claims.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 is a pictorial illustration of a front view of a foldable vanity illustrating an interior side of the foldable vanity case in accordance with an illustrative embodiment.

FIG. 2 is a pictorial illustration of a back view of the foldable vanity case illustrating an exterior of the foldable vanity case in accordance with an illustrative embodiment.

FIG. 3 is a pictorial illustration of a side view of the foldable vanity case in a closed orientation in accordance with an illustrative embodiment.

FIG. 4 is a pictorial illustration of a perspective view of the foldable vanity case in a possible usable orientation in accordance with an illustrative embodiment.

FIG. 5 is a pictorial illustration of the foldable vanity case with an optional accessory piece in accordance with an illustrative embodiment.

FIG. 6 is a pictorial illustration of a back view of the foldable vanity case demonstrating an alternative attachment member in accordance with an illustrative embodiment.

### DETAILED DESCRIPTION

In the Summary above, in this Detailed Description, the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range including that number (which may be a range having an upper limit or no upper limit, depending on the variable being defined). For example, “at least 1” means 1 or more than 1. The term “at most” followed by a number is used herein to denote the end of a range, including that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose limits include both numbers. For example, “25 to 100” means a range whose lower limit is 25 and upper limit is 100 and includes both 25 and 100.

Referring now to the drawings and the following written description of the present invention, it will be readily understood by those persons skilled in the art that the present invention is susceptible to broad utility and application. Many embodiments and adaptations of the present invention other than those described herein, as well as many variations, modifications, and equivalent arrangements will be apparent from or reasonably suggested by the present invention and the detailed description thereof without departing from the substance or scope of the present invention. This disclosure is only illustrative and exemplary of the present invention and is made merely for purposes of providing a full and enabling disclosure of the invention.

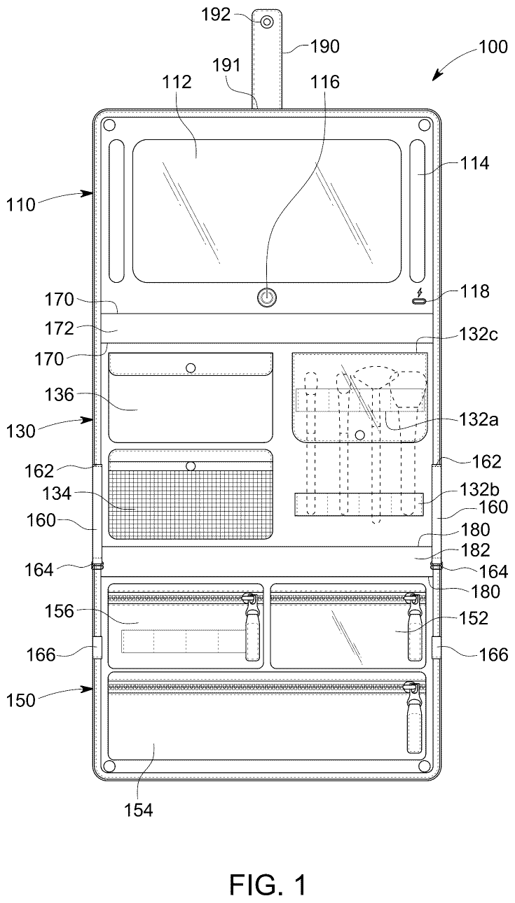

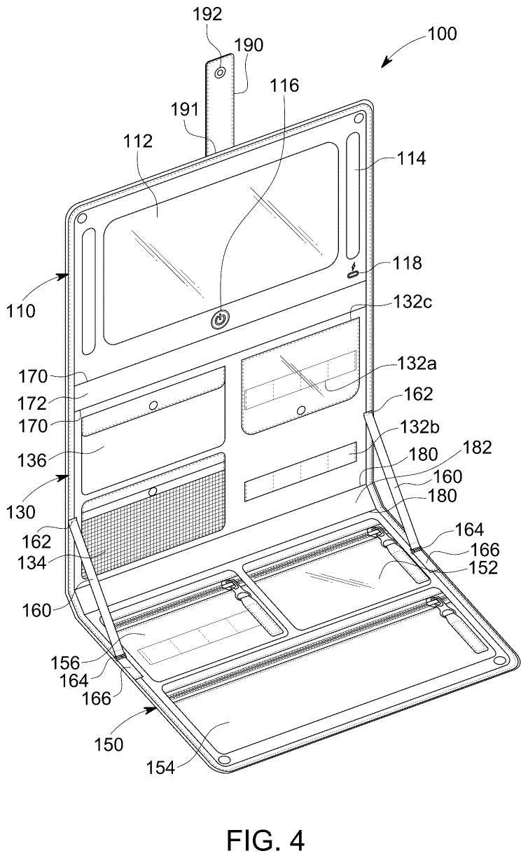

With reference to FIGS. 1 to 5, the present disclosure relates to a portable vanity case 100 that is configured for use as a compact and transportable makeup and/or grooming station. The vanity case 100 is structured as a foldable, multi-panel body that can be carried in a folded compact orientation (i.e., closed) and unfolded for use in a wide variety of environments. In one or more non-limiting embodiments, the vanity case 100 is adapted for use inside a vehicle, wherein the vanity case 100 may be attached to a vehicle visor. Such an arrangement makes access to and use of the vanity case 100 convenient. The vanity case 100 generally includes the foldable multi-panel arrangement, including mirrors, lighting, storage pockets, and brush holders. Further, the vanity case 100 is also configured with means to attach the vanity case 100 for use and a means to securely close the vanity case 100 when in the closed orientation. Additional details of these features are described below.

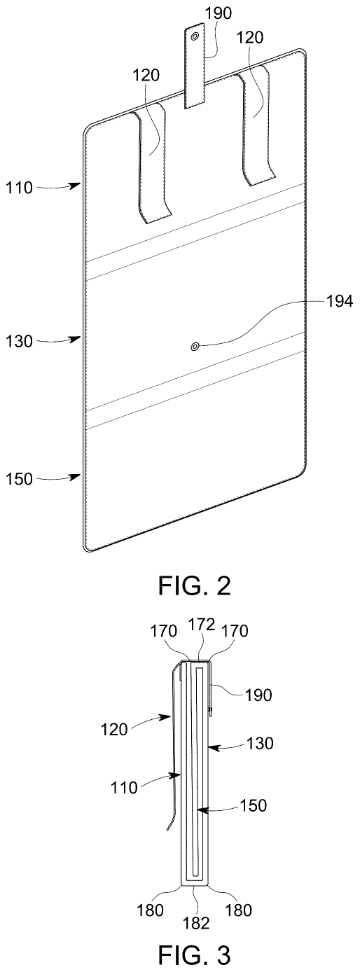

FIGS. 1 and 2 shows an example embodiment of the vanity case 100 in an unfolded state, with a front view and a back view, respectively. The front view is an interior side, and the back view is an exterior side of the vanity case 100. As mentioned above, the vanity case 100 comprises a foldable body with multiple panels which can be selectively moved between an expanded, generally planar configuration, and a closed configuration to form an enclosure. The vanity case 100 comprises a central panel 130 and at least two end panels. As seen in the example embodiments in the figures, the vanity case 100 is shown to comprise of two end panels, a first end panel 110 and a second end panel 150 with the center panel 130 between them.

Referring to FIGS. 1, 4, and 5, the first end panel 110 and the second end panel 150 are foldably coupled to opposite longitudinal edges of the center panel 130. The foldable coupling is achieved through fold zones that permit each end panel 110, 150 to be folded inwardly over the center panel 130. A first fold zone is positioned between the first end panel 110 and the center panel 130 and includes a pair of fold lines 170 that are parallel to each other and spaced apart. A second fold zone is positioned between the second end panel 150 and the center panel 130 and includes a pair of fold lines 180 that are also parallel to each other and spaced apart. In each fold zone, the pair of parallel fold lines 170, 180 define a narrow intermediate segment 172, 182, respectively. As best seen in FIG. 3, these segments 172, 182 allow the vanity case 100 in those fold zones to bend in a manner that avoids sharp creasing. This configuration at the fold zones enables the end panels 110, 150 to fold over the center panel 130 while maintaining a flat fold profile at the fold zones and providing internal volume when the vanity case 100 is closed. The multi-panel structure may be formed as a single integrated body with the fold zones provided as molded, stitched, or scored flexible regions.

In an alternate embodiment, the fold zone may include several fold lines that expand like an accordion. This type of structure uses alternating parallel folds so that the fold zone can expand to make more space if items within the foldable vanity case 100 take up more volume. Other designs for the fold zones are also contemplated within this disclosure.

The vanity case 100 includes the interior side and the opposing exterior side, as shown in FIGS. 1 and 2, respectively. The interior side faces a user when the vanity case 100 is opened for use and includes features essential for doing makeup and/or grooming, which includes mirrors, lighting, storage pockets, and brush-retaining elements. The exterior side of the vanity case 100 functions as the exterior surface of the vanity case 100 when closed. The exterior side may be fabric-covered, leather-covered, leather-like, synthetic, polymeric, or made from any suitable decorative or protective material. The exterior may be provided in various colors, finishes, or textures according to user preference and manufacturing choice.

In one or more non-limiting embodiments, the interior side of the vanity case 100 includes a main mirror 112. Preferably, the main mirror 112 is integrated into a body of the vanity. It is to be understood that the main mirror 112 may also be a removable feature and is attachable via any reasonable means such as hook and loop fasteners. In one embodiment, as shown in the figures, the main mirror 112 is mounted on the first end panel 110 and extends across a substantial portion of that panel to provide adequate viewing area. Positioning the mirror 112 on the same panel that carries the attachment means 120 allows the main mirror 112 to be located at an upper position when the case is attached to a vehicle visor, providing a stable arrangement in which the first panel 110 rests against the vehicle visor. In an alternate embodiment, the main mirror 112 may instead be provided on the center panel 130 so that its position may be lower or differently oriented relative to the user. The main mirror 112 may be rectangular, circular, oval, polygonal, or of any other suitable geometric shape. As shown in the examples, the main mirror 112 has substantially a same geometric configuration as the panel the main mirror 112 is integrated to.

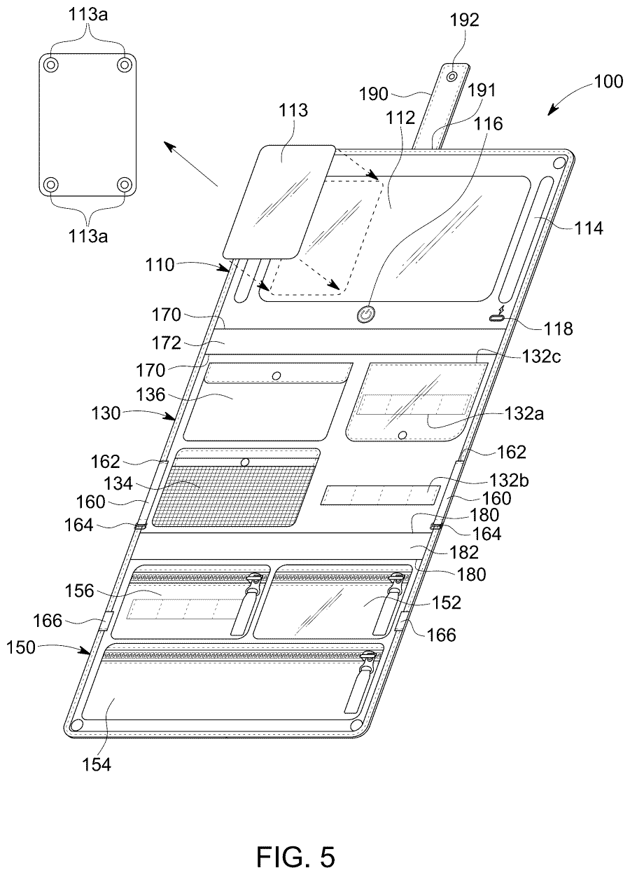

In one or more non-limiting embodiments, as shown in FIG. 5, the vanity case 100 may also include a detachable magnified mirror 113. The magnified mirror 113 is smaller than the main mirror 112, and has attachment means that allow it to be removably attached to the main mirror 112 or another surface. As shown in FIG. 5, the attachment mean includes one or more suction cups 113a that are configured on the rear side of the magnified mirror 113, so that it may be removably attached to the main mirror 112 when needed. The suction cups 113a are permanently integrated into the rear surface of the magnified mirror 113 to withstand repeated attachment and detachment. The magnified mirror 113 may also be affixed to other smooth surfaces as desired by the user. The size of the magnified mirror 113 is selected so that it may be stored within one of the storage pockets when not in use.

In one or more non-limiting embodiments, the interior side of the vanity case 100 also includes lighting that may be provided on the same panel which the main mirror 112 is mounted on and may also be positioned adjacent the main mirror 112. As shown in the figures, the lights 114 are included on the first end panel 110. In one embodiment, one or more lights 114 are arranged at opposite sides of the mirror 112, as shown in the figures. In other embodiments, the lights 114 may extend along a top edge and/or a bottom edge, or along the entire perimeter of the mirror 112. In yet another embodiment, the lights may be integrated directly into a frame of the main mirror 112. In one or more embodiment, the lights may be LED lights, or equivalent, or any lights that are practical for such a purpose. The lights 114 are powered by a rechargeable battery system and are operably connected to a power button 116. The power button 116 may control multiple brightness levels, such as by sequential pressing, or may provide a single fixed illumination level. A charging port 118, such as a USB-C port, is included to recharge the lights 114. The port 118 may be located on the same panel as the lights or in any other suitable location.

In one or more non-limiting embodiments, the interior side of the vanity case 100 further comprises various storage pockets and brush holders included on the panels that do not carry the main mirror 112. As shown in the example illustrations in the figures, the main mirror 112 is fixed on the first end panel 110, and thus the storage pockets and brush holders are fixed on the remaining panels, the center panel 130 and the second end panel 150. It is to be understood that other alternative arrangements are within this present disclosure. Further, the arrangement and configurations of these storage pockets and brush holders are not limited to the examples shown and may vary in size, location, and construction. In one example, as shown in FIGS. 1, 4, and 5, the center panel 130 may include a slip-in pocket 136 with a flap and snap-button closure, and another slip-in pocket 134 formed of an elastic mesh with a snap-button closure. The second end panel 150 may include one or more fixed zipper pockets 152, 156, with certain pockets including internal elastic bands to secure small items. A larger zippered pocket 154 may be included to accommodate bulkier accessories. Brush-holding features may also be provided, such as elastic bands 132a, 132b configured to secure the upper and lower portions of makeup brushes. A flap 132c may extend over the brush heads to protect them. The flap 132c may be fashioned from a clear or transparent material so as to allow visual identification of makeup brushes. The flap 132c may be secured with fastening means such as snap buttons. Alternative fastening means for all the storage pockets and brush holders are also within this disclosure.

In one or more embodiments, the vanity case 100 also comprises one or more support strap assemblies. As shown in FIGS. 1, 3, and 5, the one or more support assemblies are included on opposing lateral sides on the interior side of the vanity case 100. This approach provides a balanced support by supporting both lateral sides when the support assemblies are being used. Each support strap assembly includes a flexible strap member 160 having a first end 162 which is fixedly secured to the center panel 130. An opposing end of the strap member 160 includes a connecting element 164 which is configured to releasably engage with an attachment point 166 on the second end panel 150. In one embodiment, the connecting element 164 is a hook-shaped retainer and the attachment point 166 is a loop or ring allowing the hook to be inserted and held.

When the vanity case 100 is attached to a vehicle visor, the support strap assemblies 160 permit the second end panel 150 to assume a generally horizontal orientation or an angled orientation relative to the center and first end panels 130, 110, whereby the second end panel 150 may function as a support surface for items placed on it. In another embodiment, the strap assembly may use snaps, buckles, magnetic connectors, or adjustable webbing to achieve similar support functionality for balanced support. In yet another embodiment, the support strap assemblies may be provided on the first end panel 110 and the center panel 130, wherein the arrangement permits the center panel 130 to assume the horizontal orientation during use. Or alternatively, the support strap assemblies may be included on the first end panel 110 and the second end panel 150, whereby the horizontal position may be achieved for both the center and second end panels 130, 150 simultaneously.

In one or more non-limiting embodiments, the exterior side of the vanity case 100 includes the attachment member 120 for securing the vanity case 100 to a vehicle visor for use. In one non-limiting embodiment, the attachment member 120 is included on the exterior side of the first end panel 110. It is to be understood that the attachment member 120 may be included on a portion of the exterior side. The attachment member 120 arrangement and configuration is not limited to the example shown and may vary in size, location, and construction. In one non-limiting embodiment, the attachment member 120 includes one or more clipping hooks that extend outwardly from the first end panel 110. Each clip may be constructed of metal or other durable material and may be covered with the same material used on the exterior side of the vanity case 100. A fixed portion of each clip may be affixed to the panel through rivets, adhesives, stitching, or combinations thereof and may be concealed beneath the case covering material. Each clip of the attachment member 120 is positioned such that a bend in the clip is relatively in line with a top edge of the first panel 110 and a long stem part of the clip extends down toward a bottom edge of the first panel 110. The stem part may have a length that extends reasonably close to the bottom of the first panel 110 such that the first panel 110 can be stably secured on a car visor, essentially ensuring that the vanity case 100 is stably secured.

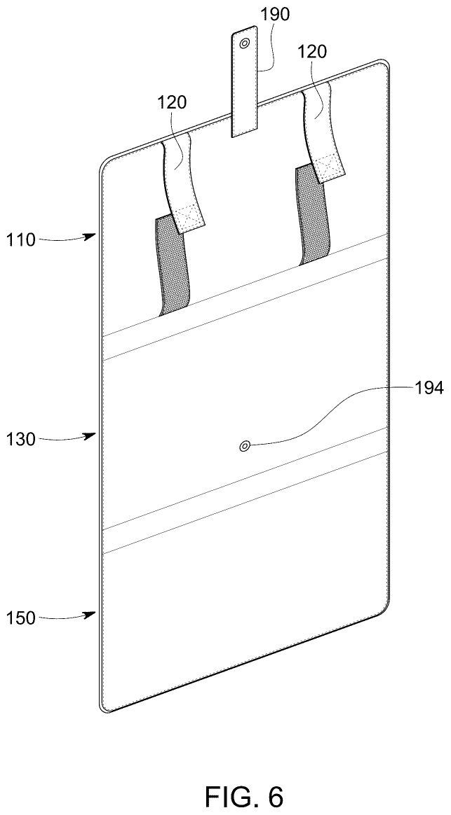

During use, the vanity case 100 is opened, and the exterior side is placed facing the visor. The visor is lowered or moved into an open position, and the clipping hooks 120 are slipped over a top edge of the visor so that the first end panel 110, which may also be carrying the mirror 112, rests flush against the visor, providing stability. In alternate embodiments, the attachment member 120 may include hook and loop bands (e.g., VELCRO) stitched at both ends to the back side of the first panel 110, as shown in FIG. 6. These bands may be placed near the lateral edges of the panel to form loops when attached over a visor. Other attachment options may include elastic bands, adjustable straps, magnetic attachments, or other securing mechanisms suitable for removably mounting the case on a visor or similar support surface.

In one or more non-limiting embodiment, the vanity case 100 also comprises a closure mechanism, which is configured to retain the vanity case 100 in a folded orientation when not in use. The closure mechanism may be fashioned with any known fastening mechanism and is not limited to the example shown and or any that are discussed herein. In one embodiment, the closure mechanism includes a closure band 190 having a first end 191 stitched to the first end panel 150 on the exterior side between the attachment means. The opposite end of the closure band 190 is configured with a metal snap 192 that mates with a snap button 194 affixed to the exterior side of the vanity case 100. The snap button 194 is positioned such that when the case is folded along the fold lines 170, 180, the closure band 190 can be stretched across and engaged with the snap button 194 to retain the vanity case 100 in a closed and compact configuration. As shown in FIG. 2, the snap button is poisoned on the center panel 130. The closure band 190 may be elastic to accommodate varying internal loads or may be formed of the same material as the exterior cover of the vanity case. Other closure options may include magnetic clasps, zipper closures, buckle straps, hook-and-loop fasteners, or hinged metal latches. Optionally, chain-type or hinged-type closures may also be used, allowing the closure element to conform to the case shape when wrapped around it.

Accordingly, the present description provides for various embodiments for a vanity case 100. The presently described vanity case 100 has several advantages including being portable and having a functional arrangement that allows the user to conveniently store, transport, and access makeup tools and grooming accessories. Many other uses and advantages are offered by the vanity case 100 as described above in one or more non-limiting embodiments in the present description.

The corresponding structures, materials, acts, and equivalents of any means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention, according to one or more embodiments described in the present description, may be practiced with modification and alteration within the spirit and scope of the appended claims. Thus, the description is to be regarded as illustrative instead of restrictive of the present invention.

What is claimed is:

1. A carrying case comprising:
a foldable body comprising multiple panels, the foldable body having an interior side and an exterior side, wherein the foldable body is movable between an open orientation and a folded orientation relative to a center panel of the multiple panels, the folded orientation forming a closed enclosure defining an internal volume;
a mirror arranged on the interior side on one of the panels of the multiple panels;
at least one storage pocket disposed on the interior side on at least one of the panels of the multiple panels other than the panel including the mirror;
at least one brush holder disposed on the interior side on at least one of the panels of the multiple panels other than the panel including the mirror;
an attachment member integrated on the exterior side of the foldable body and configured to removably attach the carrying case to a support structure; and
a closure mechanism integrated on the exterior side of the foldable body configured to retain the carrying case in the folded orientation.

2. The carrying case of claim 1, wherein the mirror has a size commensurate with the panel on which the mirror is arranged, such that the mirror extends almost an entirety of the panel.

3. The carrying case of claim 1, further comprising one or more lighting elements incorporated on the panel of the multiple panels the mirror is disposed on, wherein the one or more lighting elements are disposed around the mirror either on opposite sides of the mirror or on all four sides of the mirror, or the mirror includes the lighting elements.

4. The carrying case of claim 3, further comprising a rechargeable battery and a charging port, wherein the one or more lighting elements are electrically connected to the rechargeable battery and, the rechargeable battery is electrically connected to the charging port.

5. The carrying case of claim 3, wherein a power button is electrically connected to the one or more lighting elements, and wherein the power button is configured to provide multiple brightness settings.

6. The carrying case of claim 1, wherein a fold zone is included between adjacent panels of the multiple panels, wherein the fold zone comprises a pair of parallel fold lines defining an intermediate segment configured to create a space for the internal volume when the multiple panels are folded at the fold lines.

7. The carrying case of claim 1, wherein the at least one storage pocket includes a mesh pocket.

8. The carrying case of claim 1, wherein the at least one storage pocket includes a fastener to close a top of the at least one storage pocket.

9. The carrying case of claim 1, wherein the at least one storage pocket includes one or more elastic bands within.

10. The carrying case of claim 1, wherein the at least one brush holder comprises a plurality of elastic bands.

11. The carrying case of claim 1, wherein the at least one brush holder comprise a protective flap extending over one or more brushes secured by the at least one brush holder.

12. The carrying case of claim 1, further comprising a support strap assembly including a strap member and a connecting element, wherein the strap member is fixedly attached to the center panel of the multiple panels, and the connecting element is configured to engage with an attachment point on an adjacent panel of the multiple panels to position the adjacent panel in a generally horizontal position during use.

13. The carrying case of claim 1, further comprising a detachable magnified mirror having an attachment element configured on a back side of the detachable magnified mirror for removable engagement with a surface.

14. A portable carrying case, comprising:
a foldable body including a first end panel, a center panel, and a second end panel, the first end panel and the second end panel each being foldably connected to the center panel through a fold zone having a pair of spaced-apart fold lines;
an interior side of the foldable body including:
an integrated mirror disposed on one of the panels;
multiple storage structures disposed on at least one panel other than the panel carrying the integrated mirror;
one or more lighting elements disposed adjacent the integrated mirror and including a power button, a rechargeable battery, and a charging port;
an exterior side of the foldable body including:
an attachment member disposed on the first end panel and configured to removably attach the portable carrying case to a vehicle visor; and
a closure assembly configured to retain the foldable body in a closed configuration.

15. The portable carrying case of claim 14, wherein the integrated mirror has a size commensurate with the panel on which the integrated mirror is arranged, such that the integrated mirror extends almost an entirety of the panel.

16. The portable carrying case of claim 14, further comprising a detachable magnified mirror having an attachment member configured to attach to the integrated mirror.

17. The portable carrying case of claim 14, wherein at least one of the multiple storage structures includes a brush holder.

18. The portable carrying case of claim 14, further comprising a support strap assembly including a strap member and a connecting element, wherein the strap member is fixedly attached to the center panel, and the connecting element is configured to engage with an attachment point on the second end panel such as to angle the second end panel toward the center panel, and in a generally horizontal position when the portable carrying case is attached to a generally vertical surface.

19. The portable carrying case of claim 14, further comprising a detachable magnified mirror having an attachment element configured on a back side of the detachable magnified mirror for removable engagement with a surface.

20. The portable carrying case of claim 14, wherein the one or more lighting elements are disposed around the integrated mirror either on opposite sides of the integrated mirror or on all four sides of the mirror, or the integrated mirror includes the lighting elements.

21. The portable carrying case of claim 14, wherein a first fold zone is included between the first end panel and the center panel, and a second fold zone is included between the second end panel and the center panel, wherein each of the first and second fold zones comprise a pair of parallel fold lines defining an intermediate segment configured to create a space for the internal volume when the first and second end panels are folded at the fold lines.

22. The portable carrying case of claim 14, wherein the power button of the lighting assembly is configured to provide multiple brightness settings.
